(19) United States
(12) Patent Application Publication
(10) Pub. No.: US 2006/0219606 A1
(43) Pub. Date: Oct. 5, 2006

(54) Extra-terrestrial mining apparatus and method

(76) Inventor: Charles Robert Sutton, Prescott Valley, AZ (US)

Correspondence Address: Charles R. Sutton, 8990 E. Flapjack Rd., Prescott Valley, AZ, 86314, US

(21) Appl. No.: 11/349,430

(22) Filed: Feb. 6, 2006

Related U.S. Application Data
(60) Provisional application No. 60/650,486, filed on Feb. 7, 2005.

(51) Int. Cl. B03C 1/00

(52) U.S. Cl. 209/212

(57) ABSTRACT

An apparatus and method for producing and storing elemental Oxygen on the lunar surface where it can be used by humans to establish and maintain colonies. The Oxygen is produced by robotic miners who strip mine the lunar fines from the surface, subject them to an initial screening step for size, and then refine them through a series of steps to produce elemental Oxygen, elemental Silicon, elemental Titanium, elemental Aluminum, elemental Iron, elemental Calcium, elemental Magnesium and smaller amounts of Sodium and Potassium. The refined Oxygen can be stored in solid form as ingots or pellets or powder as long as it is not subjected to warmth. To prevent sublimation and for human convenience, the robotic mining apparatus can be programmed to produce bottles of the elemental silicon and caps of the Aluminum. It could then place Oxygen inside the bottles and cap them before storing them conveniently in a shady place.

### CROSS REFERENCE TO RELATED APPLICATIONS

This application claims the benefit of the filing date pursuant to 35 U.S.C. sec. 119 of the previously filed provisional application No. 60/650,486 filed on Feb. 7, 2005 which is hereby incorporated herein in its entirety by this reference.

### STATEMENT REGARDING FEDERALLY SPONSORED RESEARCH AND DEVELOPMENT

This invention was not made using federally sponsored research and development. The inventor retains all rights.

### BACKGROUND OF THE INVENTION

During the late 1960s and early 1970s several manned missions were sent to the surface of the Earth's Moon. Soil and rock samples were brought back for analysis. Since then several robotic probes were sent to the surface of Mars equipped with small laboratories with which they can perform chemical and biological analyses of the materials there. The United States is now embarking on a plan to pave the way for human colonization of the Earth's moon. One of the most daunting obstacles to such colonization is the need to provide the chemicals that support human life. The Moon has no atmosphere to breathe. The temperature in the shade is near zero degrees Kelvin. Unfortunately it is prohibitively expensive to carry things to the moon using our current launch and propulsion technologies. Any human needs which can be met using materials from the lunar surface must therefore be met using those materials, rather than through the expensive method of transporting such materials up from the Earth's gravity well. Elemental oxygen would be perhaps the most valuable commodity of all on the lunar surface, followed by water. Water can of course be made using elemental Oxygen and elemental Hydrogen in a combustion chamber. There is a useful by product of this process in that the expansion of gases in the combustion chamber can be used to move machinery or produce heat or electricity. Since Hydrogen is the lightest of the elements, it is the least expensive material to transport to the Moon, mole for mole. Hence, we return to the vast importance of finding Oxygen on the lunar surface. Analysis of the lunar fines brought back by the manned missions to the Moon shows that the lunar fines contain a number of Oxygen-containing compounds and mixtures thereof. Overall Oxygen comprises some 40.8% of these lunar fines.

### BRIEF SUMMARY OF THE INVENTION

This invention comprises an apparatus and method for producing and storing elemental Oxygen on the lunar surface where it can be used by humans to establish and maintain colonies. The Oxygen is produced by robotic miners who strip mine the lunar fines from the surface, subject them to an initial screening step for size, and then refine them through a series of steps to produce elemental Oxygen, elemental Silicon, elemental Titanium, elemental Aluminum, elemental Iron, elemental Calcium, elemental Magnesium and smaller amounts of Sodium and Potassium. Since the lunar surface in the shade is near absolute zero, the refined Oxygen can be stored in solid form as ingots or pellets or powder as long as it is not subjected to warmth. It would be best to keep the Oxygen in an enclosed container, nevertheless, to reduce the danger of sublimation into the vacuum of space. One possible strategy would be to program the robotic mining apparatus to produce bottles of the elemental silicon and caps of the Aluminum. It could then place Oxygen inside the bottles and cap them before storing them conveniently in a shady place. Of course, this method could also be adapted to use on other terrestrial bodies having similar characteristics to the Moon.

### BRIEF DESCRIPTION OF THE DRAWING

FIG. 1 is a flow chart of the typical chemical process used by the robotic miners to produce refined elements.

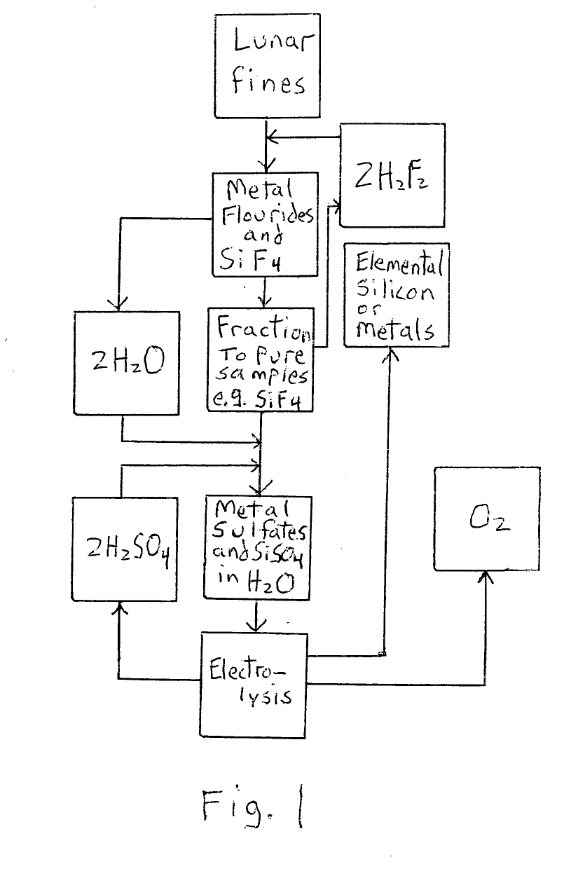

### DETAILED DESCRIPTION OF THE INVENTION

Lunar material is known to contain Ilmenite, Plagioclase (Feldspar), Pyroxene, and glass (Anorthite). The chemicals in the lunar materials are SiO2 (39.79%), TiO2 (11.44%), Al203 (10.84%), FeO (19.35%), MgO (7.65%), CaO (10.08%), Na2O (0.54%), and K2O (0.32%). Overall Oxygen is 40.8% of the lunar fine material according to analysis.

To remove Oxygen from Al203 one must first dissolve it in fused Cryolite (AlF3 . 3NaF). The Aluminum and Oxygen can then be electrolyzed from the Aluminum Oxide with Aluminum being deposited on one pole and Oxygen appearing at the other. Since there is no atmosphere to speak of on the Moon, the likely source of the electricity for the electrolysis is by use of an array of photovoltaic panels which would collect solar radiation unhindered, unless damaged by meteoritic impact. Magnesium can be prepared from Magnesium Oxide by reducing it with Ferrosilicon, an alloy of Iron and Silicon, at a temperature of about 1150 degrees C. in a vacuum. The Mg is evaporated and can be condensed into molds. The Oxygen oxidizes the Ferrosilicon. When Hydrogen is passed over Heated FeO, the Iron is reduced and water is produced. Water is another critical life support component and it can readily be hydrolyzed with electricity to produce elemental Hydrogen and Oxygen. Calcium Oxide does not melt or vaporize except at the temperature of an electric arc. It does, however, serve as a building material. It is often called quicklime. One option is to have the robotic miners sort out this substance and store it without further refinement. Cryolite can be produced from H2F2 combined with components of the lunar fines. Because of this, a semi-recycling process can be undertaken which is limited by the amount of H2F2 that can be transported to the lunar surface. When lunar fines are exposed to this compound, SiO2 will be removed and H2O and SiF4 will be evolved. The remainder fines can be heated and gaseous Hydrogen passed over them in order to reduce the Iron and produce water. Elemental Iron could then be removed using an electromagnet. Flourides of Titanium, Aluminum, Iron, Magnesium, Calcium, Sodium, and Potassium will all be formed when the lunar fines are treated with H2F2. These can be fractionated by various methods and then exposed to an appropriate strong acid such as H2SO4 to produce sulfates of the Silicon and metals plus 2HF. The 2HF is treated with water to produce H2F2. The sulfates of the metals and Silicon can then be electrolyzed to produce sulfate ion and elemental Silicon and metals. The Silicon is used to produce bottles and the Aluminum is used to produce caps. The gases such as Oxygen which are produced can be stored in the bottles which are then capped and placed into cold dark storage. Automated mining apparatuses can be found in the art, as can automated production and capping of bottles. For example, in U.S. Pat. No. 6,383,402 a multiple step plasma recipe can be undertaken by a monitoring system with remote capabilities. According to U.S. Pat. No. 6,374,982 a gripper means is disclosed to transport capped and uncapped test tubes. It has a robotic arm which can be on a rail to move things to different places within the instrument disclosed. According to U.S. Pat. No. 6,025,686 an earth moving machine is disclosed having drive systems that move a dipper along two respective paths. Motion transducers mechanically connect to the control which produces output signals. The machine can sense where the control is on a defined Cartesian coordinate plane. According to U.S. Pat. No. 4,897,221 a computer is used to separate various types of nuclear waste by tubes, containers, heat and sensors being brought to bear on the problem. The materials are moved from point to point by gas pressure. None of these patents anticipate the invention disclosed herein. They are merely means to assemble the overall apparatus disclosed herein and perform the steps disclosed herein. They show the technology exists to program a computer and peripheral sorting or chemical manipulating means to mine lunar ore into its constituent water, oxygen, silicon, or metals. Remotely operated lunar vehicles such as the Spirit and Opportunity rovers on Mars are also known to the art. The skilled artisan with enough money can make and use this invention without undue experimentation. The unexpected result of this combination is that only Hydrogen and certain recyclable substances such as H2F2 and a strong acid such as H2SO4 need to be taken to the Moon by a miner consisting of a refinery and some roving harvesters and some photovoltaic panels. Thus equipped and capable of following a program and radio instructions, the robotic mining apparatus would be able to store building materials, water, Oxygen, glass and metals for use by humans when they arrive to begin a colony.

One mole of water is produced for each mole of H2F2 used. Treating the metal flourides with one mole of H2SO4 will produce two moles of HF. This will be one mole of H2F2 when treated with water. Thus the H2F2 has been recycled while one mole of H2SO4 has produced one mole of H2O plus mine tailings heavy in metal sulfates. The solution remaining after metals are removed from metal sulfate solutions will be heavy in SO4= ions. This solution can be further electrolyzed as the water is converted to Hydrogen and Oxygen. The Oxygen will be produced at the cathode where it can be collected and stored. The Hydrogen will combine with SO4= ions to produce H2O4 solution in the water. When the reaction runs to completion the concentration can be manipulated back to desired concentration by evaporation and the excess water stored in bottles. The H2SO4 is thus recyclable.

Since there will be a large amount of mass in the acids and refinery machinery, it would be optimal to have the automated refinery be a stationary unit attended by smaller mobile units which do the physical task of collecting and screening the fines and placing them into the refinery's hopper. Possibly a third category of mechanism could be mobile and programmed to carry the bottles of product to a remote storage site. Possibly a fourth separate mechanism could be a machine which makes, fills, and caps bottles so that this process is done by a different machine than the machine refining the ores.

I claim:

1. A robotic mining system for extra-terrestrial environments comprising:
an automated refinery able to process materials presented to it so that said materials are isolated into useful chemicals; and
automated miners which collect said materials from the crust of an extra-terrestrial body and present them to said automated refinery.

2. The robotic mining system of claim 1 further comprising:
robots adapted to place said useful chemicals in a desired location.

3. The robotic mining system of claim 1 further comprising:
bottlers adapted to store said useful chemicals in a stable form.

4. The robotic mining system of claim 3 wherein said bottlers form bottles and said bottlers place said useful chemicals into said bottles.

5. The robotic mining system of claim 3 wherein said bottlers form ingots of said useful chemicals.

6. A method of storing fluids on extraterrestrial bodies comprising the steps of:
forming bottles from solids derived from the crust of said extra-terrestrial body; placing said fluids inside said bottles; and
enclosing said bottles with said solids derived from the crust of said extra-terrestrial body.

7. A method of mining useful chemicals from extra-terrestrial bodies comprising the steps of:
accumulating solids from the crust of said extra-terrestrial body; and screening said solids.

8. The method of mining useful chemicals from extra-terrestrial bodies from claim 7 further comprising the steps of:
exposing said solids to H₂F₂ to produce a first slurry;
fractioning said first slurry to purify its components; and
exposing said components to a strong acid.

9. The method of mining useful chemicals from extra-terrestrial bodies from claim 7 wherein Oxygen is released from said components using electrolysis.

10. The method of mining useful chemicals from extra-terrestrial bodies from claim 7 comprising the following additional steps:
reducing Iron in said components by exposing it to gaseous Hydrogen; and
separating said Iron using an electromagnet.

11. The method of mining useful chemicals from extra-terrestrial bodies from claim 8 wherein said fractioning is done chemically.

12. The method of mining useful chemicals from extra-terrestrial bodies from claim 8 wherein said fractioning is done using a centrifuge.

13. The method of mining useful chemicals from extra-terrestrial bodies from claim 8 wherein said fractioning is done through distillation.
